(19) United States
(12) Patent Application Publication
(10) Pub. No.: US 2008/0241276 A1
(43) Pub. Date: Oct. 2, 2008

(54) Portable bio-chemical decontaminant system and method of using the same

(75) Inventors: Alan David Willey, Cincinnati, OH (US); Vladimir Gartstein, Mason, OH (US); James Robert Tinlin, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company

(21) Appl. No.: 11/981,037

(22) Filed: Oct. 31, 2007

Related U.S. Application Data
(60) Provisional application No. 60/855,445, filed on Oct. 31, 2006.

(51) Int. Cl. A01N 59/00; A01P 1/00

(52) U.S. Cl. 424/661

(57) ABSTRACT

The present invention relates to a portable bio-chemical decontaminant system and methods of using the same. Specifically, the present invention provides a portable bio-chemical decontaminant system that is rapidly effective across a broad range of chemical and biological weapons agents. The disclosed portable bio-chemical decontaminant system electrochemically generates a decontaminant solution at the point of use obviating the need to transport corrosive or reactive chemicals, and dramatically simplifies the logistics of delivering an effective bio-chemical decontaminant system to wherever it may be needed. The portable bio-chemical decontaminant system electrochemically generates chlorine dioxide and hypobromite.

### CROSS REFERENCE TO RELATED APPLICATION

This application claims the benefit of U.S. Provisional Application No. 60/855,445, filed Oct. 31, 2006;

### FIELD OF THE INVENTION

The present invention generally relates to a portable bio-chemical decontaminant system and methods of using the same. In particular, the invention relates to a bio-chemical composition comprising chlorine dioxide and hypobromite formed electrochemically in a portable decontaminant system.

### BACKGROUND OF THE INVENTION

Sources of highly-infective, potent diseases that may be used as biological warfare agents (BWA's) include a variety of microorganisms such as spores, bacteria and viruses. Diseases that have been considered for use as BWA's include Anthrax, Ebola, Bubonic Plague, Cholera, Tularemia, Brucellosis, Q fever, Machupo and Smallpox, among others.

Chemical warfare agents (CWA's) are classified into several categories according to the manner in which they affect the human body and include blood agents, vesicants, pulmonary agents, incapacitating agents, lachrymatory agents and nerve agents. Known chemical warfare agents include V-type nerve agents (VX), G-type nerve agents (including sarin and sonan) and H-type vesicants such as sulfur mustards.

Despite international prohibitions, biological and chemical warfare (“BC”) agents continue to be produced and stockpiled. As a result, there is a need for a portable decontaminant system capable of rapidly and simultaneously minimizing the effects associated with human exposure to a variety of both types of BC agents. Consistent with this need is the desire to provide a method of rapidly decontaminating equipment and other surfaces. There are currently some BC decontamination solutions (“DS”) that can be employed; but, none of them are sufficiently effective against both biological and chemical warfare agents, and all of them have drawbacks in their usage.

For instance, DS2 is an effective organic-based decontaminant; however, one component has been identified as a teratogen. DS2 will also damage alkyl paint and other materials. Another common DS is GD5 (Odenwalde Weke Rittersbach (OWR) in Germany) which is a monoethanolamine-based decontaminant. It is similar to DS2 and is also very expensive. Another common DS is classical chlorine bleach oxidants (HTH, STB, CASCAD, German Emulsion) which are highly alkaline and/or corrosive. Their alkaline and/or corrosive nature restricts their use to hardened surfaces. A final common DS is hydrogen peroxide solutions (Decon Green, DF200, Surfactant Decon). The peroxide solutions are fortified with activators capable of reacting with all classes of biological and chemical warfare agents, and are environmentally attractive since the peroxide decomposes to water and oxygen following reaction.

Unfortunately, the storage stability of hydrogen peroxide is limited and may pose some logistical concerns in extreme environments. As a result, there are many considerations that must be taken into account in the formulation and deployment of DS such as if it will be harmful to the personnel or equipment to which it is applied and the stability of the DS, e.g., some chemicals may be capable of effective decontamination; but, may not be safe to store or ship. Consequently, the use of such chemicals may be severely limited to their point of production.

For instance, chlorine dioxide is known to have biocidal effects and has the ability to provide some benefits against BC agents. Chlorine dioxide is a small, highly energetic molecule, and a free radical even while in dilute aqueous solution (EPA Guidance Manual, Alternative Disinfectants and Oxidants, April 1999). Chlorine dioxide reacts via oxidation and not chlorination. Chlorine dioxide is easy to generate and functions as a highly selective oxidant due to its unique, one electron transfer mechanism where it is reduced to chlorite (ClO₂⁻).

The ability of chlorine dioxide to decontaminate Anthrax spores is well documented by Larson et al., at Dugway Proving Ground, using chlorine dioxide (AD-B283 317). Using gaseous chlorine dioxide at various concentrations (125 to 1050 parts per million (ppm) and humidity's (30 to 92 percent) the sporicidal effects were demonstrated at various times intervals up to 12 hours using three strains of Bacillus anthracis and three other strains of Bacillus simulants. In these tests, it was demonstrated that the effect of humidity was more important in the killing of the spores than the concentration of the chlorine dioxide gas at the concentrations tested. Sporicidal effects were achieved faster at higher humidity's, with modest influence from the chlorine dioxide concentration, which suggests that aqueous chlorine dioxide may be equally efficacious.

One important physical property of chlorine dioxide is its high solubility in water. Chlorine dioxide does not hydrolyze to any appreciable extent but remains in solution as a dissolved gas. Given the reactivity of chlorine dioxide in the gas phase with BWA's and Anthrax, along with its solubility and demonstrated reactivity with various organics in aqueous solutions (Envrion. Sci. Technol.; 1997, 21, 1069-1074, J. Org. Chem.; 1963; 28(10); 2790-2794), makes the application of aqueous chlorine dioxide to decontamination a very promising investigation.

However, one principal obstacle to the operational use of chlorine dioxide for decontamination is being able to easily generate it on site as needed and to avoid problems associated with storage of the chemical precursors. Chlorine dioxide cannot be compressed or stored as a gas because it is explosive under pressure. Chlorine dioxide is considered explosive at concentrations that exceed 10 percent by volume in air. Therefore, it is never shipped and must be generated at the site of use. Conventional devices that generate chlorine dioxide rely on cylinders of chlorine or acid solutions, which must be metered and mixed before use; thereby, requiring flow metering devices, control systems, and mixing tanks.

Chlorine dioxide can be formed by sodium chlorite reacting with gaseous chlorine, hypochlorous acid, or hydrochloric acid. The reactions are: 2NaClO₂+Cl₂(g)⇄2ClO₂(g)+2NaCl; or 2NaClO₂+HOCl⇄2ClO₂ (g)+NaCl+NaOH; or 5NaClO₂+HCl⇄4ClO₂ (g)+5NaCl+2H₂O. These reactions explain how generators can differ even though the same feedstock chemicals are used, and why some should be pH controlled and others are not so dependent on low pH. These reactions involve the use of a range of chemicals that provide handling and transportation issues. For example, chlorine gas (Cl₂) is very toxic, hypochlorite (HOCl) is a strong oxidizer and hydrochloric acid (HCl) is corrosive. The transport and handling of these materials makes these systems less attractive than one where simple and stable salts are used.

Two emergent technological approaches to generation are electrochemical generation using sodium chlorite, and a chlorate-based technology that uses concentrated hydrogen peroxide and sulfuric acid. Hydrogen peroxide acting as a reducing agent generates chlorine dioxide from chlorate. The reaction is: 2NaClO₃+H₂O₂+H₂SO₄⇄4ClO₂+O₂+Na₂SO₄+2H₂O.

One disadvantage to this method of generation involves the storage and stability of the peroxide precursor and because sulfuric acid must also be used. Moreover, chlorine dioxide, although effective against Anthrax, is not effective against other types of chemical warfare agents, e.g., G-type nerve agents. Therefore, chlorine dioxide is a troublesome material to transport and handle at high aqueous concentrations, due to its low stability and high corrosivity. This has required end users to generate chlorine dioxide on demand, usually employing a precursor such as sodium chlorite (NaClO₂) or sodium chlorate (NaClO₃).

As a result, existing decontamination solutions may be effective at neutralizing some BC agents; but, may ultimately be harmful to equipment, environment, and personnel. Additionally, some chemicals may be effective in providing adequate decontamination; but, may not be shipped easily and only be produced at the point of use by bulky components. Still further, existing decontamination systems cannot effectively decontaminate all types of BC agents. In some instances, they are good for use only with V-type nerve agents or H-type vesicants; but, provide no benefit against G-type nerve agents.

Consequently, there is a need for the development, integration, and optimization of technology for a portable bio-chemical decontaminant system and methods of using the same that can be used for a wide variety of decontamination applications, including G-type nerve agents. The portable decontaminant systems can be used against all types of BC agents, e.g., biological and chemical warfare agents, and even for commercial applications, such as by hospitals, first emergency responders, or by consumers in their homes, and the like that would have a need for such technology.

### SUMMARY OF THE INVENTION

The present invention relates to a portable bio-chemical decontaminant system and methods of using the same. Specifically, the present invention provides a portable bio-chemical decontaminant system that is rapidly effective across a broad range of chemical and biological weapons agents. The disclosed portable bio-chemical decontaminant system electrochemically generates a decontaminant solution at the point of use obviating the need to transport corrosive or reactive chemicals, and dramatically simplifies the logistics of delivering an effective bio-chemical decontaminant system to wherever it may be needed.

In one embodiment of the invention, a method for decontaminating a surface comprises the steps of: providing an electrochemically generated effluent solution comprising: from about 10 to about 1500 ppm of halogen dioxide and from about 100 to about 1,000 ppm of hypohalite; and applying said solution over said surface for decontamination, wherein said decontamination is selected from the group consisting of chemical decontamination, biological decontamination and combinations thereof.

In another embodiment of the invention, a method for decontamination of a surface comprises the steps of: providing an electrochemically generated effluent solution comprising: from about 500 to about 1500 ppm of a halogen dioxide and from about 1000 to about 100,000 ppm of a nucleophile; and applying said solution to said surface, wherein, said nucleophile is selected from the group consisting of N-oxides, hydroxylamines, amines, and combinations thereof; and said decontamination is selected from the group consisting of chemical decontamination, biological decontamination and combinations thereof.

In still yet another embodiment of the invention, a portable decontamination system comprises: at least one flow-through electrolysis cell, wherein said cell further comprises: an anode, a cathode, and a flow path, wherein said cathode is spaced apart a distance from said anode such that said flow path is defined there between; a fluid reservoir in fluid communication with said flow path; a feed solution located in said fluid reservoir, said feed solution comprising: a solvent, a halogen dioxide salt, and a nucleophilic agent; a direct current power supply; and an outlet port in fluid communication with said flow path through which an effluent solution is expelled; such that when said system is powered, said feed solution flows from said fluid reservoir into said flow path, and said direct current power supply provides electric current from said anode through said feed solution to said cathode, whereby the feed solution is electrolyzed such that at least a portion of said feed solution is converted into electrochemically generated chemicals.

In still yet another embodiment of the invention, a electrochemically generated decontamination effluent solution comprises: from about 500 to about 1500 ppm of a halogen dioxide; and from about 1000 to about 100,000 ppm of a nucleophile; wherein said nucleophile is selected from the group consisting of hypohalites, N-oxides, hydroxylamines, amines, and combinations thereof.

### BRIEF DESCRIPTION OF THE DRAWINGS

While the specification concludes with claims particularly pointing out and distinctly claiming the present invention, it is believed that the same will be understood from the following description taken in conjunction with the accompanying drawings in which:

FIGS. 1A-1D illustrates various embodiments of the portable decontaminant system comprising a flow-through electrolysis cell.

FIG. 2 is a blow-up of the embodiment of the portable decontaminant system comprising a flow-through electrolysis cell illustrated in FIG. 1A.

FIG. 3 illustrates a flow-through electrolysis cell 20 that may be used in the portable decontaminant systems illustrated in FIGS. 1A-1D.

FIG. 4 illustrates a cross-sectional view of the flow-through electrolysis cell 20 of FIG. 3 taken through line 4-4.

FIG. 5 is a cross-sectional view of a flow-through electrolysis cell 20 comprising at least one porous electrode.

FIG. 6 illustrates a flow-through electrolysis cell 20 that electrochemically generates an oxidant and a nucleophile.

FIG. 7 illustrates the antimicrobial efficacy of electrochemically generated chlorine dioxide.

FIG. 8 illustrates the auto-generation effect of the chemical reaction between VX and chlorine dioxide.

FIG. 9 pictorially illustrates the auto-generation effect of the chemical reaction between VX and chlorine dioxide in 15 second intervals.

FIG. 10 pictorially illustrates the chemical reaction between HD and chlorine dioxide.

FIG. 11 graphically illustrates hypobromite catalysis.

FIG. 12 graphically illustrates various hypobromite concentrations and effects on decontamination removal.

FIG. 13 illustrates the effect of molar ratios on the removal of G-agent stimulant diisopropyl fluorophosphate FIG. 14 pictorially illustrates a multi-pass system with multiple flow-through electrolysis cells.

FIG. 15 illustrates various N-oxides and their corresponding chemical structures that can be used as nucleophiles.

FIG. 16 illustrates various amines, oxides and salts, and their corresponding chemical structures that can be used as nucleophiles.

FIG. 17 illustrates the cocktail of Bacillus cereus strains used.

FIG. 18 illustrates the results of aqueous sporocidal results when exposed to electrochemically generated chlorine dioxide.

FIG. 19 illustrates the results of In Vitro suspension results when exposed to electrochemically generated chlorine dioxide.

FIG. 20 illustrates the results of In Vitro surface results when exposed to electrochemically generated chlorine dioxide.

Still other objects, advantages, and novel features of the present invention will become apparent to those skilled in the art from the following detailed description, which is simply, by way of illustration, various modes contemplated for carrying out the invention. As will be realized, the invention is capable of other different obvious aspects all without departing from the invention. Accordingly, the figures and descriptions are illustrative in nature and not restrictive.

### DETAILED DESCRIPTION OF THE INVENTION

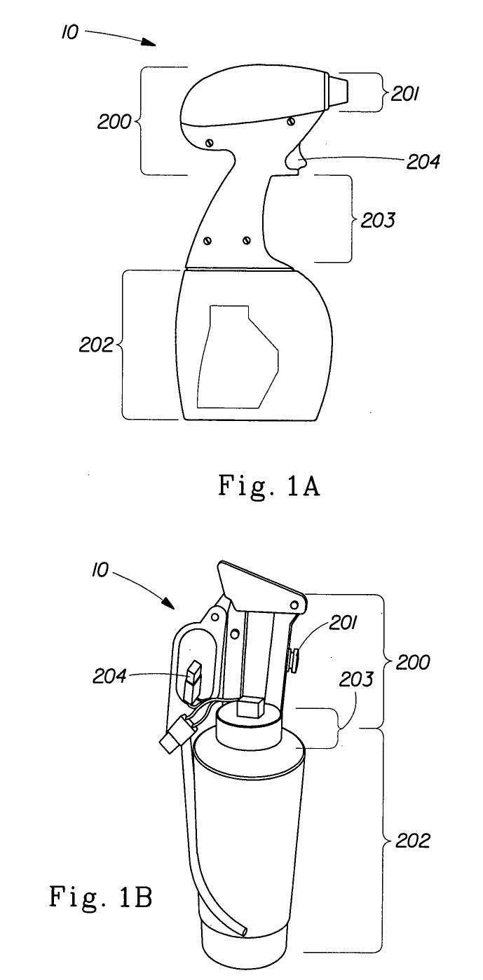

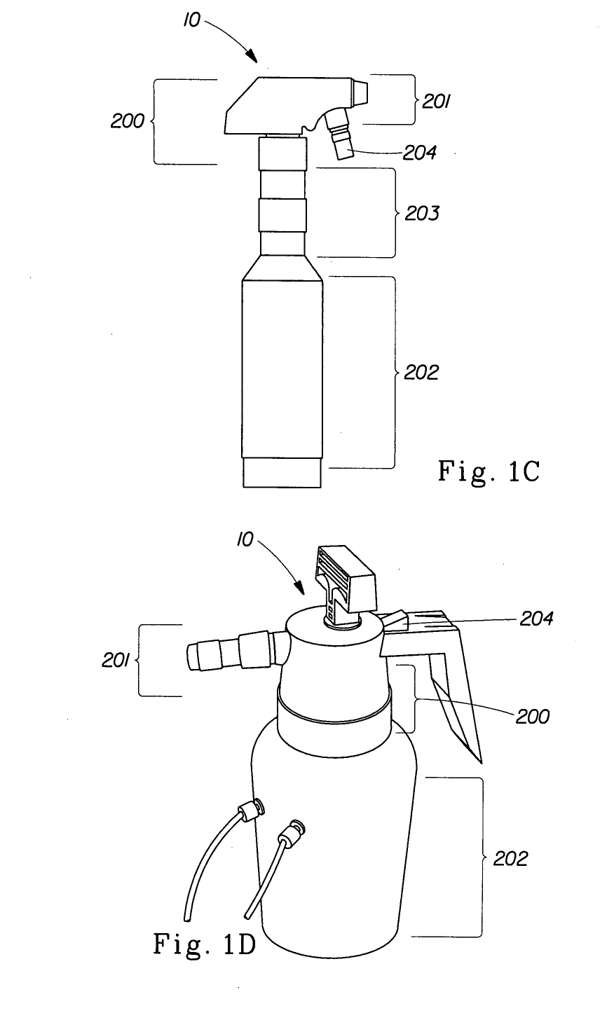

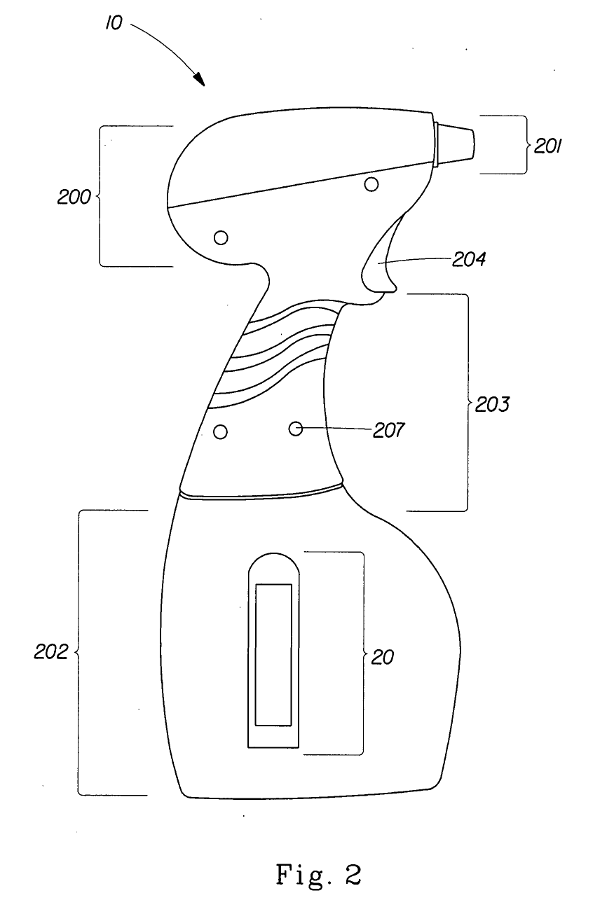

In the following detailed description, reference is made to the accompanying figures (FIGS. 1A-20) which form a part hereof and illustrate specific exemplary embodiments by which the invention may be practiced. It should be understood that like reference numerals represent like elements throughout the figures (FIGS. 1A-20). These embodiments are described in sufficient detail to enable those skilled in the art to practice the invention. It is to be understood that other embodiments may be utilized, and that structural changes, chemical changes, electrical changes, logical changes, and the addition or omission of steps may be made without departing from the spirit and scope of the present invention.

The term “comprising” refers to various components, elements, structures or steps that may be conjointly employed, although additional components, elements, structures or steps may be utilized, if desired. Accordingly, the term “comprising” may encompass the more restrictive terms “consisting essentially of” and “consisting of”.

Chlorine dioxide is generated from a halogen dioxide salt, e.g., chlorite salts. The electrochemical generation of chlorine dioxide from aqueous sodium chlorite is represented in the reaction: NaClO₂+H₂O+e-⇄Na⁺ (aq)+ClO₂-(aq)+H₂O. The electrochemical generation of hypobromite is represented in the reaction: Br-+2OH—<->BrO—+H₂O+2e.

This electrochemical method of in situ generation of chlorine dioxide and hypobromite offers several unique distinct advantages over classical generation methods, especially when generated by the disclosed portable decontaminant system. Use of a single and stable precursor, for each chemical provided, eliminates the usual metering and mixing of several different chemicals and facilitates ease of packaging, storage and logistical support. Simplicity of operation also minimizes training of personnel for optimum use. Miniaturization of a portable bio-chemical decontaminant device allows for it to be easily transported and used by soldiers in the field, or by any others that need access to such a decontaminant system, e.g., hospitals, firefighters, emergency responders, and the like. The highly reactive properties of aqueous chlorine dioxide, and the ability to be generated on site in a portable lightweight unit as needed, offers an attractive alternative approach to unique decontamination needs.

### Portable Decontaminant System

In FIGS. 1A-1D, various embodiments of the portable decontaminant system 10 comprising a flow-through electrolysis cell 20 are illustrated. The system 10 generates chlorine dioxide from sodium chlorite and hypobromite, from a halide by flowing electrical current through an aqueous feed solution that passes through the flow-through electrolysis's cell's chamber. The flow-through electrolysis cell 20 comprises at least a pair of electrodes: an anode and a cathode. The portable decontaminant system 10 also comprises a cell chamber through which an aqueous feed solution passes, and includes passages adjacent to the anode and cathode. The passages include narrow surface layers adjacent to both the cathode and anode surface where the conversion reactions occur.

Different embodiments of the portable decontaminant system 10 are illustrated in FIGS. 1A-1D. The portable decontaminant system 10 comprises at least one flow-through electrolysis cell 20 which is illustrated in FIG. 1A. Each of the other embodiments of the portable decontaminant system 10 depicted in FIGS. 1B-1D also comprise at least one flow-through electrolysis cell 20. The portable decontaminant system 10 further comprises at least a main handle portion 200, a nozzle 201, a body portion 202, a neck region 203, and a trigger 204. A trigger nozzle sprayer 201, illustrated in FIG. 1A, can be used which can provide approximately 1 ml per spray. The pump nozzle sprayer 201, illustrated in FIG. 1D, can be used which can provide approximately 300 ml/min. It should be appreciated that the trigger nozzle sprayer 201 can be any shape, size, and have a flow rate other than disclosed herein depending on the desired utility of the portable decontaminant system 10.

It should be appreciated that the portable decontaminant system 10 can be any shape or size other than those depicted in FIGS. 1A-1D. For instance, the portable decontaminant system 10 may be as large as a backpack that can be worn by a soldier on the field of battle, or the size of a typical fire extinguisher bottle kept in a school or hospital. As such, the present invention also contemplates the formation of a portable backpack decontamination system, e.g., approximately 2 L and larger. This would allow the incorporation of a liquid pumping system with a spray nozzle to allow a soldier to reach underneath and on tops of contaminated vehicles.

Still referring to FIGS. 1A-1D, the nozzle sprayer 201 may be manually adjustable to provide a mist or a fine stream of effluent solution. The body portion 202 and neck region 203 may hold the aqueous fluid solution or, may comprise separate compartments that store the precursors used to form the effluent solution. In other words, there may be additional compartments separated from each other within the body portion 202 and neck region 203. The flow-through electrolysis cell 20 is in fluid communication with the body portion 202; neck region 203, main handle portion 200, and nozzle sprayer 201. In other words, the effluent solution will exit the portable decontaminant system 10 through nozzle sprayer 201.

Referring now to FIG. 2, which is a blow-up image of FIG. 1A, a portable decontaminant system 10 with a trigger nozzle sprayer 201 is illustrated. The portable decontaminant system 10 comprises at least a main handle portion 200, a nozzle sprayer 201, a body portion 202, a neck region 203, and a trigger 204. In this embodiment, a single flow-through electrolysis cell 20 is used. However, multiple flow-through electrolysis cells could be used, if desired. The portable decontaminant system 10 is a battery-operated pump sprayer in FIG. 2. It is operated by at least one double AA battery. In another embodiment, it is operated by 3 double AA batteries. It should be appreciated that any portable battery source may be used. The portable decontaminant system 10 allows for the effluent solution to be applied where and when needed.

It should also be appreciated that the portable decontaminant systems 10, illustrated in FIGS. 1A-1D, are reusable. In other words, once the systems 10 have been completely discharged, e.g., substantially unable to discharge anymore effluent solution through nozzle 201, the aqueous feed solution can be replenished. For instance, a pre-packaged powder or concentrate could be added with the addition of water. New batteries could also be used. As FIG. 2 illustrates, the portable decontaminant system 10 can be dis-assembled by removing screws 207. However, the portable decontaminant system 10 can also be assembled and disassembled by a number of other methods such as with no screws, or, by turning, twisting, or having a removable neck portion 203 from the body portion 202 or main handle portion 200.

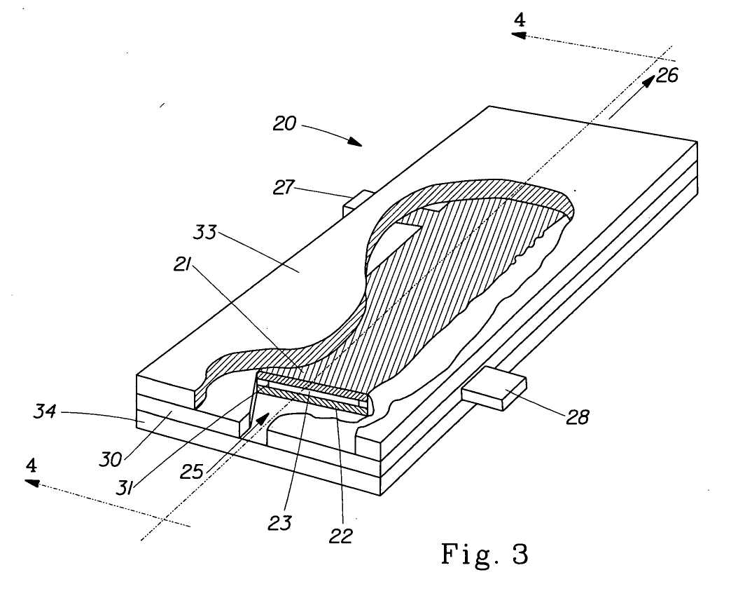

In one embodiment of the present invention, as illustrated in FIG. 3, the portable decontaminant system 10 comprises a flow-through electrolysis cell 20 with an anode 21 and a confronting (and preferably, co-extensive) cathode 22 that are separated by a cell chamber 23 that has a shape defined by the confronting surfaces of the pair of electrodes 21, 22, and the shape of the portable decontaminant system 10 itself (FIGS. 1A-1D). The cell chamber 23 has a cell gap, which is the perpendicular distance between the two confronting electrodes 21, 22. Typically, the cell gap will be substantially constant across the confronting surfaces of the electrodes. The cell gap is preferably greater than 0.5 mm and 5 mm or less, and more preferably 1 mm or greater and 3 mm or less. The flow-through electrolysis cell 20 can also comprise two or more anodes 21, or two or more cathodes 22 (not illustrated). The anode 21 and cathode 22 plates are alternated so that an anode 21 is confronted by a cathode 22 on each face, with a cell chamber 23 therebetween.

Generally, the flow-through electrolysis cell 20 will have one or more inlet openings in fluid communication with each cell chamber 23, and one or more outlet openings in fluid communication with the chambers 23. The inlet opening is also in fluid communication with the source of aqueous feed solution, such that the aqueous feed solution can flow into the inlet, through the chamber, and from the outlet of the flow-through electrolysis cell 20. The effluent can itself be a treated solution, where the aqueous feed solution contains microorganisms or some other oxidizable source material that can be oxidized in situ by the chlorine dioxide and hypobromite that is formed.

FIG. 3 illustrates merely one embodiment of a flow-through electrolysis cell 20 of the present invention. The flow-through electrolysis cell 20 comprises an anode 21 electrode and a cathode 22 electrode. The electrodes 21, 22 are held a fixed distance away from one another by a pair of opposed non-conductive electrode holders 30 having electrode spacers 31 that space apart the confronting longitudinal edges of the anode 21 and cathode 22 to form a cell chamber 23 having a chamber gap. The chamber 23 has a cell inlet 25 through which the aqueous feed solution can pass into of the cell 20, and an opposed cell outlet 26 from which the effluent solution can pass out of the flow-through electrolysis cell 20. The assembly of the anode 21 and cathode 22, and the opposed plate holders 30 are held tightly together between a non-conductive anode cover 33 (shown partially cut away) and cathode cover 34, by a retaining structure (not shown) that can comprise non-conductive, water-proof adhesive, bolts, or other structures, thereby restricting exposure of the two electrodes 21, 22 only to the aqueous feed solution that flows through the chamber 23. Anode lead 27 and cathode lead 28 extend laterally and sealably through channels made in the electrode holders 30.

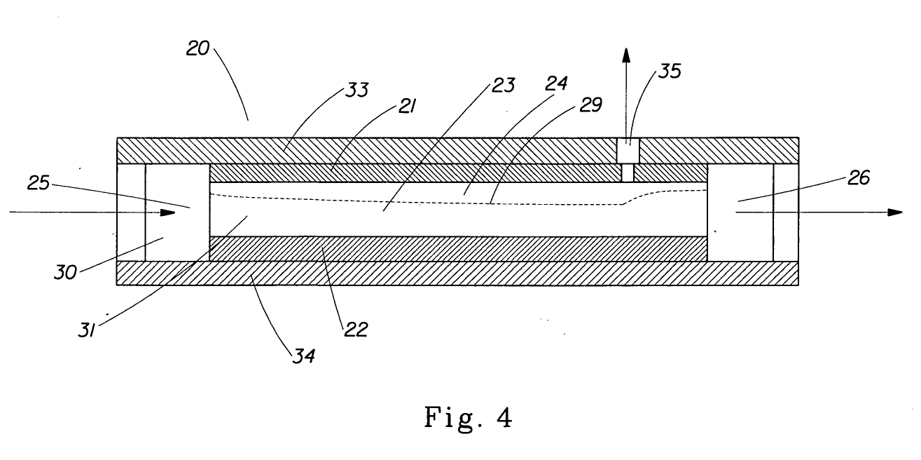

In FIG. 4, the flow-through electrolysis cell 20 comprises an anode outlet 35. The anode outlet 35 removes a portion of the electrolyzed feed solution flowing in the passage 24 adjacent the anode 21 as an anode effluent. The remainder of the cell's effluent solution exits from the cell outlet 26, and will be referred to as the cathode effluent and the cathode outlet, respectively. It should be appreciated that the flow-through electrolysis cell 20 can comprise a cathode outlet, alone or in combination with the anode outlet 35, if desired.

The electrodes 21, 22 can have any shape that effectively conducts electricity through the aqueous feed solution between itself and the opposing electrode, and can include, but is not limited to, a planar electrode, an annular electrode, a spring-type electrode, and a porous electrode. The anode 21 and cathode 22 electrodes can be shaped and positioned to provide a substantially uniform gap between a cathode 22 and an anode 21 electrode pair, as shown in FIG. 4. On the other hand, the anode 21 and the cathode 22 can have different shapes, different dimensions, and can be positioned apart from one another non-uniformly. The important relationship between the anode 21 and the cathode 22 is for a sufficient flow of electrical current through the anode 21 at an appropriate voltage to promote the conversion of the salts within the cell passage adjacent the anode 21 and cathode 22.

The electrodes 21, 22 are commonly metallic, conductive materials, though non-metallic conducting materials, such as carbon, can also be used. The materials of the anode 21 and the cathode 22 can be the same, but can advantageously be different. To minimize corrosion, chemical resistant metals are preferably used. Preferred anode metals are titanium, stainless steel, platinum, palladium, iridium, ruthenium, as well as iron, nickel and chromium, and alloys and metal oxides thereof. Preferred cathode metals are uncoated titanium, carbon, zinc, stainless steel, alloys and metal oxides thereof, and even more preferred is titanium.

For example, more preferred electrode materials made of a valve metal such as titanium, tantalum, aluminum, zirconium, tungsten or alloys thereof, which are coated or layered with a Group VIII metal that is preferably selected from platinum, iridium, and ruthenium, and oxides and alloys thereof. One preferred anode is made of titanium core and coated with, or layered with, ruthenium, ruthenium oxide, iridium, iridium oxide, and mixtures thereof, having a thickness of at least 0.1 micron, preferably at least 0.3 micron.

In other embodiments, a metal foil having a thickness of about 0.03 mm to about 0.3 mm can be used. Foil electrodes should be made stable in the cell 20 so that they do not warp or flex in response to the flow of liquids through the passage that can interfere with proper electrolysis operation. The use of foil electrodes is particularly advantageous when the cost of the device must be minimized, or when the lifespan of the portable decontaminant system is expected or intended to be short, generally about one year or less. Foil electrodes can be made of any of the metals described above, and are preferably attached as a laminate to a less expensive electrically-conductive base metal, such as tantalum, stainless steel, and others.

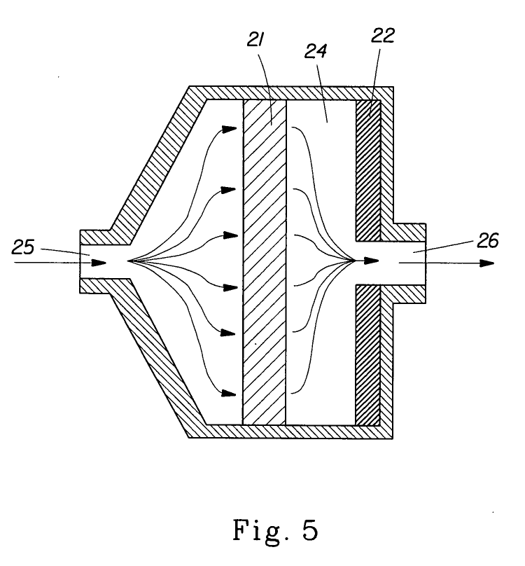

A particularly preferred anode 21 or cathode 22 electrode of the present invention is a porous, or flow-through anode and/or cathode as illustrated in FIG. 5. The porous electrodes have a large surface area and large pore volume sufficient to pass there through a large volume of aqueous feed solution. The plurality of pores and flow channels in the porous electrodes provide a greatly increased surface area providing a plurality of passages, through which the aqueous feed solution can pass. Porous media useful in the present invention are commercially available from Astro Met Inc. in Cincinnati, Ohio, Porvair Inc. in Henderson, N.C., or Mott Metallurgical in Farmington, Conn., among others.

Preferably, the porous electrodes 21, 22 have a ratio of surface area (in square centimeters) to total volume (in cubic centimeters) of more than about 5 cm⁻¹, more preferably of more than about 10 cm⁻¹, even more preferably more than about 50 cm⁻¹ and most preferably of more than about 200 cm⁻¹. Preferably, the porous electrodes 21, 22 have porosity of at least about 10%, more preferably of about 30% to about 98%, and most preferably of about 40% to about 70%.

The flow path of the aqueous feed solution through the porous electrodes 21, 22 should be sufficient, in terms of the exposure time of the solution to the surface of the electrodes, to convert the salts. The flow path can be selected to pass the aqueous feed solution in parallel with the flow of electricity through the electrodes 21, 22 (in either the same direction or in the opposite direction to the flow of electricity), or in a cross-direction with the flow of electricity. The porous electrodes 21, 22 permit a larger portion of the aqueous feed solution to pass through the passages adjacent to the electrodes surface, thereby increasing the proportion of the salts conversion.

FIG. 5 illustrates a flow-through electrolysis cell comprising a porous electrode 21. The porous electrode has a multiplicity of capillary-like flow passages 24 through which the aqueous feed solution can pass adjacent to the electrode surfaces within the porous electrode. In the flow-through electrolysis cell of FIG. 5, the aqueous feed solution flows in a parallel direction to the flow of electricity between the electrodes. A flow-through electrolysis cell 20, and its various embodiments, that may be used in conjunction with the disclosed portable decontaminant system 10 are described in U.S. patent application Ser. No. 10/674,669.

### Electrical Current Supply

An electrical current supply provides a flow of electrical current between the electrodes 21, 22 and across the passage of aqueous feed solution passing across the electrodes. In some embodiments, the preferred electrical current supply is a rectifier of household (or industrial) current that converts common 100-230 volt AC current to DC current.

In other embodiments involving portable or small, personal use systems, such as the disclosed portable decontaminant systems in FIGS. 1A-1D, a preferred electrical current supply is a battery or set of batteries, preferably selected from an alkaline, lithium, silver oxide, manganese oxide, or carbon zinc battery. The batteries can have a nominal voltage potential of 1.5 volts, 3 volts, 4.5 volts, 6 volts, or any other voltage that meets the power requirements of the electrolysis device. Most preferred are common-type batteries such as “AA” size, “AAA” size, “C” size, and “D” size batteries having a voltage potential of 1.5 V. It should be appreciated that smaller voltage batteries may be used, if desired. Two or more batteries can be wired in series (to add their voltage potentials) or in parallel (to add their current capacities), or both (to increase both the potential and the current). Re-chargeable batteries and mechanical wound-spring devices can also be employed.

Another alternative is a solar cell that can convert (and store) solar power into electrical power. Solar-powered photovoltaic panels can be used advantageously when the power requirements of the flow-through electrolysis cell 20 draws currents below 2000 milliamps across voltage potentials between 1.5 and 9 volts.

The electrical current supply can further comprise a circuit for periodically reversing the output polarity of the battery or batteries in order to maintain a high level of electrical efficacy over time. The polarity reversal minimizes or prevents the deposit of scale and the plating of any charged chemical species onto the electrode surfaces. The polarity reversal functions may be applied when using confronting anode 21 and cathode 22 electrodes.

### Electrochemically Generated Chlorine Dioxide and Hypobromite

In one aspect, the present invention employs an electrical current passing through an aqueous feed solution between an anode and a cathode to convert the halogen dioxide salt precursor dissolved within the solution into a halogen dioxide. The aqueous feed solution is an electrolytic solution. The term ‘electrolytic solution’ is used in its broadest sense and means any chemical solution that can flow through the passage of the disclosed flow-through electrolysis cell 20, and that contains sufficient electrolytes to allow a measurable flow of electricity through the aqueous feed solution.

Water, except for deionized water, is a preferred aqueous feed solution, and can include: sea water; water from rivers, streams, ponds, lakes, wells, springs, cisterns, mineral water, city or tap water, rain water, and brine solutions, among others. Electrolytic solutions can also include blood, plasma, urine, polar solvents, electrolytic cleaning solutions, beverages, among others. An electrolytic solution of the present invention is chemically compatible if it does not chemically explode, burn, rapidly evaporate, or if it does not rapidly corrode, dissolve, or otherwise render the portable decontaminant system unsafe or inoperative, in its intended use. The aqueous feed solution can naturally comprise a halogen dioxide salt precursor and halide salt, or, it can be added, if desired.

In one embodiment, the halogen dioxide salt precursor is a sodium chlorite, i.e., NaClO₂, and the resulting halogen dioxide is chlorine dioxide. Halogen dioxide salts have the general structure A(XO₂)_{y} where X and is F, Cl, Br, or I and A is an alkali or alkali earth metal including Li, Na, K, Ca, Mg and y is 1 for alkali metals and 2 for alkali earth metals. It should be appreciated that although the present invention, in one aspect, relates to a halogen dioxide product such as chlorine dioxide, other halogen dioxide products are also contemplated such as iodine dioxide, bromine dioxide and fluorine dioxide.

The aqueous feed solution may also comprise an alkali halide that is converted into a hypohalite. However, separate aqueous feed solutions can be used if it is desired to keep the hypohalite separate from the halogen dioxide. In one embodiment, the alkali halide is NaBr and the resulting hypohalite is hypobromite. An alkali halide is a compound formed from elements of groups I and VII of the periodic table. A hypohalite is any salt of a hypophalous acid, having a general formula M(OX)ₙ. Hypobromite is any salt or ester of hypobromous acid. It should be appreciated that other halide salts are contemplated by the present invention such as hypochlorite, hypobromite, hypoiodite, and hypofluorite. Moreover, additional salts can be used such as a persulphate which is a stable peroxygen chemical that is electrochemically generated from sulphate.

When an aqueous solution flows through the chamber 23 of the flow-through electrolysis cell 20 of the portable decontaminant system 10 (FIGS. 1A-1D), and electrical current is passed between the anode 21 and the cathode 22, chemical reactions occur that involve the water, as well as one or more of the other salts or ions contained in the aqueous feed solution.

For example, at the anode 21, within a narrow layer of the aqueous feed solution in the passage adjacent to the anode surface, the following reaction occurs: 6H₂O [symbol] O₂ (g)+4H₃O⁺+4e⁻. The following chemical reactions occurring at the anode 21 and cathode 22 for the salt precursors: Anode: ClO2⁻→ClO₂+e⁻ and Br-+2OH-<=>BrO—+H2O+2e; and, at the Cathode: H₂O+e⁻→½H₂+OH⁻ and Na⁺+OH⁻NaOH.

Flow dynamics, which include the movement of molecules in a flowing aqueous solution by turbulence, predicts that the conversion of chlorite salts to chlorine dioxide will increase as the solution flow path nears the anode surface layer. This concept applies to both the anode and cathode, and for both reactions. Consequently, the portable decontaminant system 10 preferably maximizes the flow of the aqueous feed solution through the surface layer adjacent the anode 21, in order to maximize the conversion of chlorite to chlorine dioxide, and the surface layer adjacent the cathode 22, in order to maximize the conversation of the hypohalite into hypobromite.

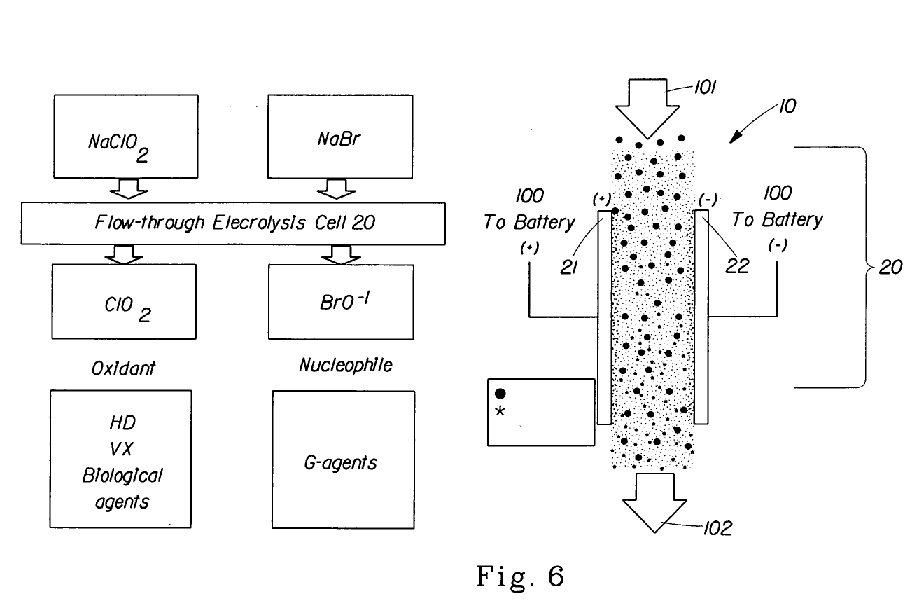

Referring now to FIG. 6, a cross-section of a portable decontaminant system 10 with a flow-through electrolysis cell 20 is illustrated. The flow-through electrolysis cell 20 comprises an anode electrode 21 and cathode electrode 22. The anode 21 and cathode 22 are electrically connected to a power source 100, e.g., a battery. An aqueous feed solution 101 enters the flow-through electrolysis cell 20 from the top and exits the bottom as an effluent solution 102. In one embodiment, NaClO₂ enters as an aqueous feed solution 101 and exits as an effluent solution 102, e.g., ClO₂. Concurrently, or, in a different flow-through electrolysis cell 20, NaBr enters as an aqueous feed solution 101 and exits as an effluent solution 102, e.g., BrO⁻¹.

The electrochemically generated chlorine dioxide is an excellent oxidant against CWA's such as HD (mustard gas) and VX, and also effective against a wide range of biological agents. The chlorine dioxide oxidizes HD to sulfoxide and sulfone, and VX is neutralized to ethyl methyl phosphonic acid. The electrochemically generated chlorine dioxide is a gas that is soluble in water and organics. It evaporates completely, minimizing any environmental impact, and is chemically effective over a broad pH range. It can also be generated as needed from a stable precursor with no special storage conditions, has a stable and long storage life, and no transportation restrictions. 200 ppm of chlorine dioxide can be used for sterilization. The electrochemically generated chlorine dioxide obtain greater than 600 ppm levels when formed with the disclosed portable decontamination systems 10 (FIGS. 1A-1D).

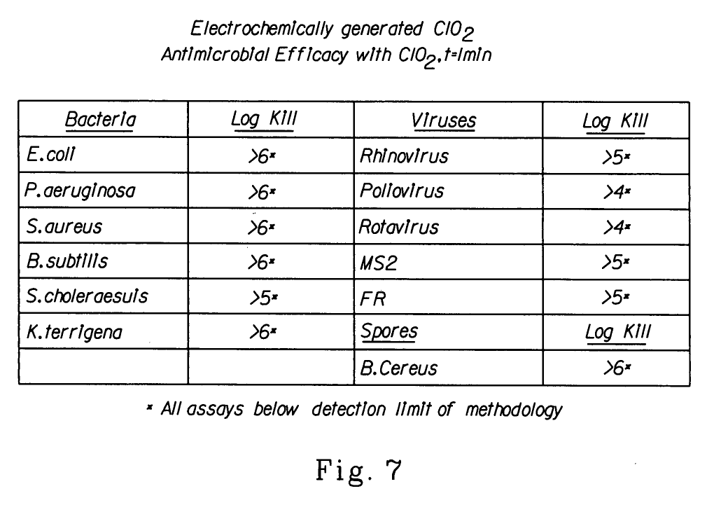

FIG. 7 illustrates the antimicrobial efficacy of electrochemically generated chlorine dioxide. The antimicrobial efficacy of electrochemically generated chlorine dioxide, with a lapse time period of one minute, results in a log kill greater than 6 for bacteria such as E. coli, P. aeruginosa, S. aureus, B. subtilis, and K. terrigena. It results in a log kill greater than 5 for bacteria such as S. choleraesuis. The antimicrobial efficacy of electrochemically generated chlorine dioxide, with a lapse time period of one minute, results in a log kill greater than 5 for viruses such as the rhinovirus, MS2, and FR. It results in a log kill greater than 4 for viruses such as poliovirus and rotavirus. It results in a log kill greater than 6 for virus spores such as B. Cereus. All assays measured were below the detection limit of the methodology.

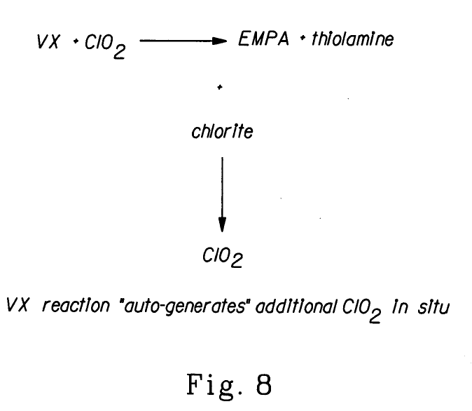

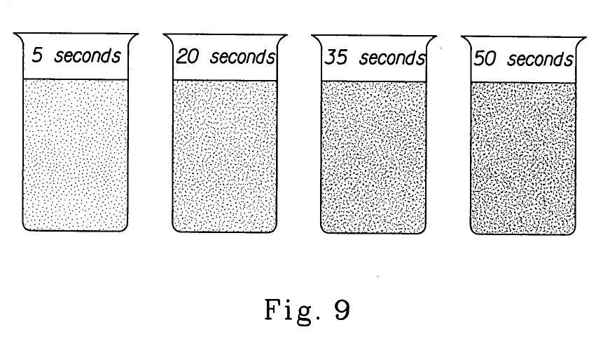

A VX reaction with electrochemically generated chlorine dioxide is illustrated in FIG. 8. The P—S bond cleavage by chlorine dioxide produces EMPA as the sole phosphorus product. EMPA generates additional chlorine dioxide by acidification of chlorite. It should be appreciated that not all of the NaClO₂ is converted to ClO₂ in the portable decontaminant system 10 (FIGS. 1A-1D). The additional chlorine dioxide generated in situ by EMPA accelerates the rate and increases the reactive capacity for VX, e.g., chlorine dioxide is auto-generated. Consequently, the capacity to neutralize VX is very high. The addition of EMPA to a chlorite solution is tested and the auto-generation of ClO₂ occurs. In FIG. 9, VX (1:50 by volume) is added to a 2M chlorite solution. Each beaker displayed in FIG. 9 represent 15 second intervals in sequence. The color darkens as higher chlorine dioxide concentrations are auto-generated. For example, chlorine dioxide is formed by acidifying chlorite. As VX reacts, it produces an acid that causes the pH to drop leading to production of chlorine dioxide.

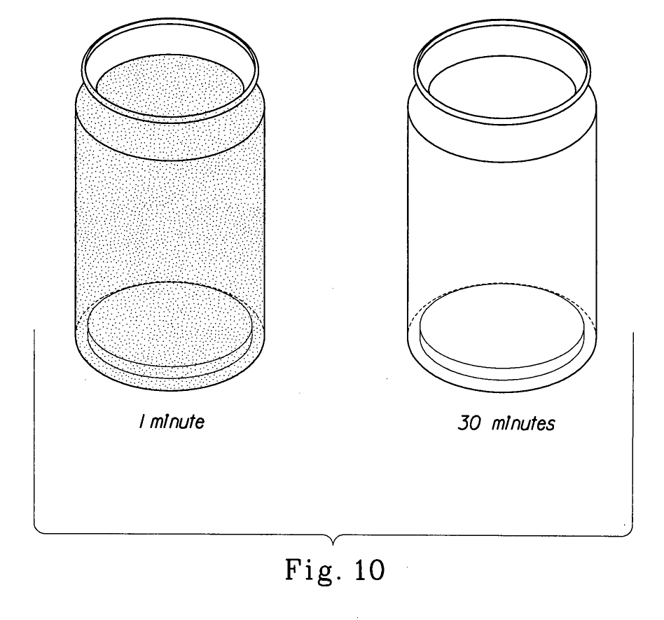

A HD reaction with electrochemically generated chlorine dioxide and hypobromite is illustrated in FIG. 10. The oxidation by electrochemically generated ClO₂/BrO— produces approximately 81% bis(2-chloroethyl) sulfoxide, approximately 4% 2-bromoethyl 2-chloroethyl sulfoxide, approximately 12% bis(2-chloroethyl) sulfone, and approximately 3% of unidentified compounds. The poor solubility of HD in water limits performance; but, the electrochemically generated chlorine dioxide gas readily partitions into HD from an aqueous solution, and there is no undesirable side-chain chlorination detected. Chlorine dioxide is soluble in the HD and concentrates there when HD is in contact with solutions of chlorine dioxide. Chlorination is an undesirable reaction with HD that chlorine dioxide does not cause.

A surfactant may be used to enhance HD solubility. In FIG. 10, it is shown that ClO₂ readily partitions into HD phase. In FIG. 10, HD is added (1:20) to an aqueous electrochemically generated chlorine dioxide solution without stirring or modifiers (surfactants or solvents). The electrochemically generated chlorine dioxide is concentrated into an HD droplet within 1 minute. Consequently, the disclosed portable decontaminant system 10 (FIGS. 1A-1D) is ideal to generate electrochemically generated chlorine dioxide and hypobromite and to effectively neutralize HD.

However, electrochemically generated chlorine dioxide has no effect on Sarin (GB) or Soman (GD). This is where the addition of an electrochemically generated nucleophile, such as hypobromite, is advantageous. The electrochemically generated hypobromite is an excellent nucleophile against BWA's Sarin and Soman, e.g., G-agents. The hypobromite is a catalyst for rapid GD hydrolysis and, it also neutralizes HD and VX. Like electrochemically generated chlorine dioxide, electrochemically generated hypobromite can be generated from a stable precursor with no special storage conditions, has a stable and long storage life, and no transportation restrictions.

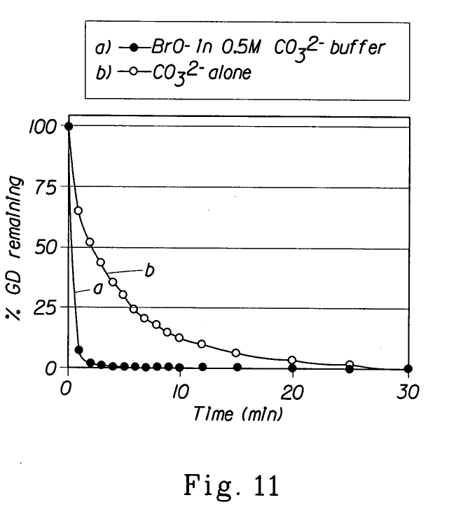

In a GD reaction, electrochemically generated chlorine dioxide does not react with GD. A nucleophile, such as hypobromite, is electrochemically generated by the portable decontaminant system 10 (FIGS. 1A-1D), and catalyzes GD hydrolysis in alkaline solutions. A GD-acid is the sole product. In FIG. 11, a GD reaction is illustrated. GD is added by 1:50 loading by volume, e.g., 50 fold excess of decontamination solution over the amount of agent, i.e., if there is 1 ml of agent, then 50 ml of decontamination solution is used in the test. The buffer used is CO₃²⁻. As can be seen, the combination of electrochemically-generated hypobromite and the buffer provides almost 100% removal of GD under approximately 2 minutes.

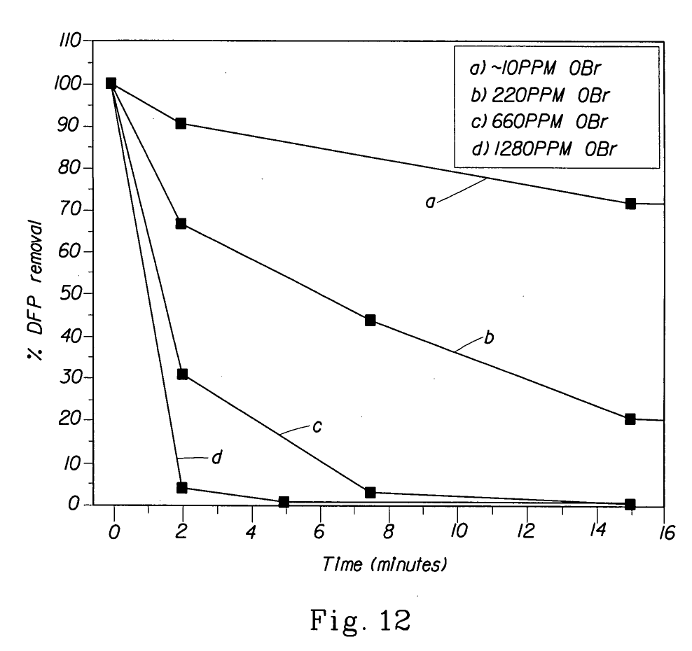

It is also noted that the higher the hypobromite concentration, the quicker decontaminants are removed. For instance, in FIG. 12, the disclosed portable decontaminant systems 10 comprising flow-through electrolysis cell 20 (FIGS. 1A-1D) produces hypobromite in situ from a stock solution of NaBr. The generation of hypobromite requires less battery power when compared to electrochemically generating chlorine dioxide. For instance, the REDOX potentials for the chemical reactions are provided as follows relative to SHE: Br-+2OH-<=>BrO—+H₂O+2e=−0.76V vs. SHE, compared to chlorine dioxide with ClO2-<=>ClO₂ (aq)+e=−0.954V vs. SHE. The term “SHE” refers to the standard hydrogen electrode, and is a standard way of describing the potential, e.g., voltage, required to make a reaction occur. The higher the concentration of hypobromite, the higher the efficacy and lower amount of time is required to remove the decontaminant.

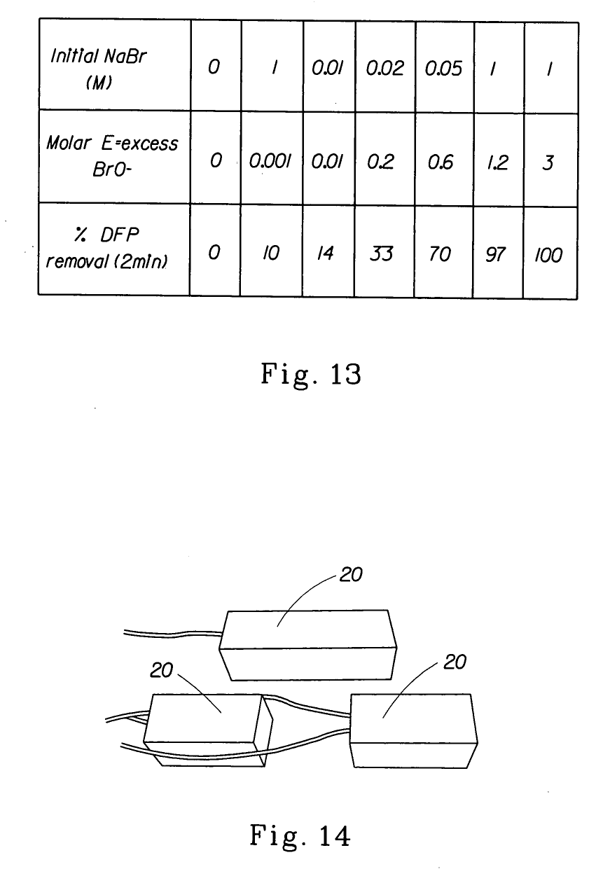

Referring now to FIG. 13, the concentration of hypobromite should range from about 1.2 to about 1.5. This can occur by either increasing the initial sodium bromide used in the portable decontaminant system 10, or, by manipulating the geometry or creating a multi-pass system for the flow-through electrolysis cell 20.

FIG. 14 illustrates a multi-pass system with multiple flow-through electrolysis cells 20. In the multipass system the effluent from one electrolysis cell is fed into a second electrolysis cell to increase the conversion of salts. As a result, the combination of the nucleophile and oxidant electrochemically generated by the present invention is ideal for use.

### Aqueous Feed Solution

The aqueous feed solution comprises the halogen dioxide salt and alkali halide, which for simplicity will be exemplified herein after by the most preferred halite salt, sodium chlorite, i.e., NaClO₂, and sodium bromide, i.e., NaBr as the alkali halide. Sodium chlorite is not a salt ordinarily found in tap water, well water, and other water sources. Consequently, the sodium chlorite salt is added to the aqueous feed solution at a desired concentration generally of at least 100 parts per million (ppm). The term ppm, as used herein, means that one ppm is substantially equivalent to 1 milligram of something per liter of water (mg/l). The NaBr salt is added to the aqueous feed solution at a desired concentration generally of at least 100 ppm. The desired concentration of the sodium chlorite salt and sodium bromide is dependent on the desired decontaminant targeted.

For instance, sanitation use requires a concentration of from about 500 to about 1000 ppm, disinfection use requires a concentration of from about 1000 to 5000 ppm, and sterilization use requires a concentration of from about 2000 to about 10,000 ppm. The term sanitation, as used herein, means that some object or mammal has been treated in order to be substantially free of live bacteria, other microorganisms, or some harmful chemical. The term disinfection, as used herein, means that some object or mammal has been treated in order to destroy live bacteria, other microorganisms, or some harmful chemical. The term sterilization, as used herein, means that some object or mammal has been treated to be substantially free of live bacteria, other microorganisms, or some harmful chemical.

The precursor material from which the halogen dioxide is formed is referred to as a halogen dioxide salt. The more common and most preferred halogen dioxide salt is the corresponding halite salt of the general formula MXO₂, wherein M is selected from alkali and alkali-metal earth metal, and is more commonly selected from sodium, potassium, magnesium and calcium, and is most preferably sodium; and wherein X is halogen and is selected from Cl, Br, I and F, and is preferably Cl. The halogen dioxide salt can comprise two or more salts in various mixtures.

The aqueous feed solution also comprises the alkali halide, which for simplicity will be exemplified herein after by the most preferred halide, NaBr. The sodium bromide is not ordinarily found in tap water, well water, and other water sources. Consequently, an amount of the bromine halide is added to the aqueous feed solution at a desired concentration generally of at least 0.1 (10,000 ppm)-2 (200,0000 ppm) molar, and preferably 0.5 (50,000 ppm)-1.5 (150,000 ppm) molar. The desired concentration of the sodium bromide is dependent on the desired decontaminant targeted.

The precursor material from which the hypohalite is formed is referred to as an alkali halide. The more common and most preferred hypohalite has the general formula M(OX)ₙ, wherein M is selected from alkali and alkali earth metals, and is more commonly selected from alkali metals, and is most preferably Na or K; and wherein X is F, Cl, Br, I and is preferably Cl, Br. The alkali halide can comprise two or more alkali halides in various mixtures.

The range of chlorine dioxide and hydrobromite conversion that is achievable in the flow-through electrolysis cells of the present invention generally ranges from greater than 0.01% to less than 100%. The level of conversion is dependent most significantly on the design of the portable decontaminant system 10, as well as on the electrical current properties used in the portable decontaminant system 10. The aqueous feed solution, as it exits the portable decontaminant system 10 from an outlet becomes an effluent solution that is discharged. The term ‘effluent solution’ means that the aqueous feed solution contains a higher level of decontaminant properties, e.g., is a decontaminant biological and chemical solution, than it originally contained prior to undergoing electrolysis.

The aqueous feed solution comprises one or more other salts in addition to the sodium chlorite. These salts can be used to enhance the sanitation, disinfection and sterilization and neutralization performance of the effluent that is discharged from the portable decontaminant system, or to provide other mixed oxidants in response to the passing of electrical current through the portable decontaminant system. As indicated above, the preferred other salt is an alkali halide, and is most preferably sodium bromide.

The aqueous feed solution comprising the sodium chlorite can be provided in a variety of ways. A solid, preferably powdered, form of the sodium chlorite can be mixed into an aqueous solution to form a dissolved solution, which can be used as-is as the aqueous feed solution or, if in a concentrated solution can be subsequently diluted with water. Preferably, a concentrated solution of about 0.5 to about 50% sodium chlorite can be used.

The aqueous feed solution comprising the source of halide ions can supplement the ordinary levels of halide ions in many water sources, such as tap water, to generate higher concentration levels of mixed oxidants in the effluent. The local source of halide ions can be a concentrated brine solution, a salt tablet in fluid contact with the reservoir of electrolytic solution, or mixtures thereof. A preferred localized source of halide ions is a solid form, such as a pill or tablet, of halide salt, such as sodium bromide. Preferably, a concentrated solution of about 0.5% to about 50% sodium bromide can be used.

As a result, the present invention can provide additional sources of halogen dioxide salt and/or halide salt, with a method for delivering the halogen dioxide salt and/or halide salt to the aqueous feed solution. This embodiment is used in situations when the aqueous feed solution does not contain a sufficient amount, or any, of the halogen dioxide salt and/or halide salt. The local source of halogen dioxide salt and/or halide salt can be released into a stream of the aqueous feed solution, which then passes through the portable decontaminant system. The local source of halogen dioxide salt and/or halide can also be released into a portion of a reservoir of the aqueous feed solution, which portion is then drawn into the portable decontaminant system. Preferably, all the local source of halogen dioxide salt and/or halide salt passes through the portable decontaminant system, to maximize the conversion to halogen dioxide and hypohalite. The local source of halogen dioxide salt and/or halide salt can also supplement any residual levels of halogen dioxide salt and/or halide salt already in the aqueous feed solution, if any. For purposes of a simplified description, the halogen dioxide salt and halide salt will be collectively referred to herein as ‘the two salts.’

The local source of the two salts can be delivered by a single salt chamber comprising the salts, in preferably a pill or tablet form, through which a portion of the aqueous feed solution passes, thereby dissolving a portion of the salts to form the aqueous feed solution. The salt chamber can comprise both salts, or, two separate salt chambers can be used to keep them separate. The salt chamber can comprise a salt void formed in the body of the device that holds the portable decontaminant system, which is positioned in fluid communication with the portion of aqueous feed solution that passes through the portable decontaminant system. Any water source can be used to form the aqueous feed solution

The pH of the aqueous feed solution comprising the halogen dioxide salt and halide salt is preferably 7, and more preferably 12. The aqueous feed solution is preferably maintained at a pH of 8, and more preferably at a pH of 9.5. Most preferably, the pH of the feed solution is between about 8 and about 10.

The aqueous feed solution can be fed to the portable decontaminant system from a batch storage container. Alternatively, the aqueous feed solution can be prepared continuously by admixing a concentrated aqueous solution of sodium bromide and sodium chlorite with a second water source, and passing continuously the admixture to the portable decontaminant system. Optionally, a portion of the aqueous feed solution can comprise a recycled portion of the effluent from the portable decontaminant system. The aqueous feed solution can comprise a combination of any of the forgoing sources. The aqueous feed solution can flow continuously or periodically through the portable decontaminant system.

### Chlorine Dioxide and Hypobromite Effluent

The discharged effluent solution containing the electrochemically generated chlorine dioxide and hypobromite is removed from the flow-through electrolysis cell 20 and is used, for example, as an aqueous sanitation, disinfection or sterilization solution. The effluent solution can be used as-made by direct delivery to a site that is neutralized by the chlorine dioxide and hypobromite. Oxidation is the main chemical reaction; however, the hypobromite reacts with G-agents by nucleophilic displacement. The site can be a BWA which is destroyed when mixed or contacted with the effluent solution. The site can also be an article or object on which neutralizable material is affixed or positioned.

The structure for passing the aqueous feed solution into the cell can be a pump or an arrangement where gravity or pressure forces aqueous feed solution from a storage container into the cell. The structure for delivering the aqueous effluent can be a pump as disclosed above, or can be a separate pump or gravity/pressure arrangement. The system 10 can also comprise a recirculation line through which a portion of the effluent solution is returned back to the inlet of the flow-through electrolysis cell 20. As herein before described, re-circulating the effluent solution back to the cell 20 increases the total conversion of the halogen dioxide salt to the halogen dioxide product, and alkali halide into the nucleophile. The structure for returning the depleted effluent solution can be a collection tank with additional structures for recycling the depleted effluent solution back to the source.

In one embodiment, a low powered portable flow-through electrolysis cell 20 is provided that can use the current and voltage delivered by conventional household batteries. The flow-through electrolysis cells 20 can come in various sizes, with anodes having a surface area of from about 0.1 cm² to about 60 cm².

One particular embodiment of the present invention comprises a spray nozzle having, in the spray effluent solution pathway leading to the spray nozzle, a flow-through electrolysis cell 20 with an anode having a surface area of from about 0.1 cm² to about 20 cm², more preferably from about 2 cm² to about 8 cm². The spray effluent solution can be pumped to the flow-through electrolysis cell 20 by a trigger-actuated pump or an electrically-driven motorized pump. Such spray pump units will typically spray from about 100 to about 300 cc/min. of spray solution.

In the aforementioned embodiment, the effluent solution can comprise the generation of about equal amounts of chlorine dioxide and hypobromite. Typically, a mixed salt solution (sodium chlorite and sodium bromide) containing 0.5-2 molar of each of the two salts is used. This aqueous feed solution is passed through the flow-through electrolysis cell 20 and provides an effluent solution comprising about 1000 ppm of a mixture of chlorine dioxide and hypobromite which are in approximate equal amounts, e.g., about 500 ppm of electrochemically generated chlorine dioxide and about 500 ppm of electrochemically generated hypobromite. The effluent solution can also be buffered if it is desired to have a specific pH. Common buffers that can be used are those described in the “CRC Handbook.of Chemistry and Physics published by the CRC press In a preferred embodiment, carbonate and/or bicarbonate is used as the buffer for pH's of about 9 to about 10.5. In the absence of buffer, the electrolysis will lead to the formation of hydroxide ions that will raise the pH, and in some embodiments, this would be detrimental to efficacy or may lead to damage of surfaces undergoing decontamination.

It should be appreciated that the ratio of electrochemically generated chlorine dioxide to electrochemically generated hypobromite can be in different ratios than disclosed above. For instance, the concentration of the salts in the aqueous feed solution can be manipulated to change the final effluent solution ratio of electrochemically generated chlorine dioxide to electrochemically generated hypobromite. The desired application will determine the final ratios.

### Nucleophiles

For the decontamination application, the hypobromite is being used as a nucleophile. Chlorine dioxide is very effective, as illustrated above, against BWA's and most of chemical weapons agents (CWA). However, it is not effective against one class of CWA nerve agent known as G-agents. This class includes sarin, soman and tabun. These agents are sensitive to nucleophiles and this is why the nucleophiles are preferably added to the aqueous feed solution. Additional stable nucleophiles can also be used such as N-oxides and hydroxylamines as a way to provide G-agent neutralization. These are effective but need higher levels than hypobromite. Generating hypohalites using the flow-through electrolysis cell 20, such as hypobromite, is highly effective at G-agent neutralization. The nucleophiles can be selected from the group consisting of N-oxides, hydroxylamines, amines, and combinations thereof.

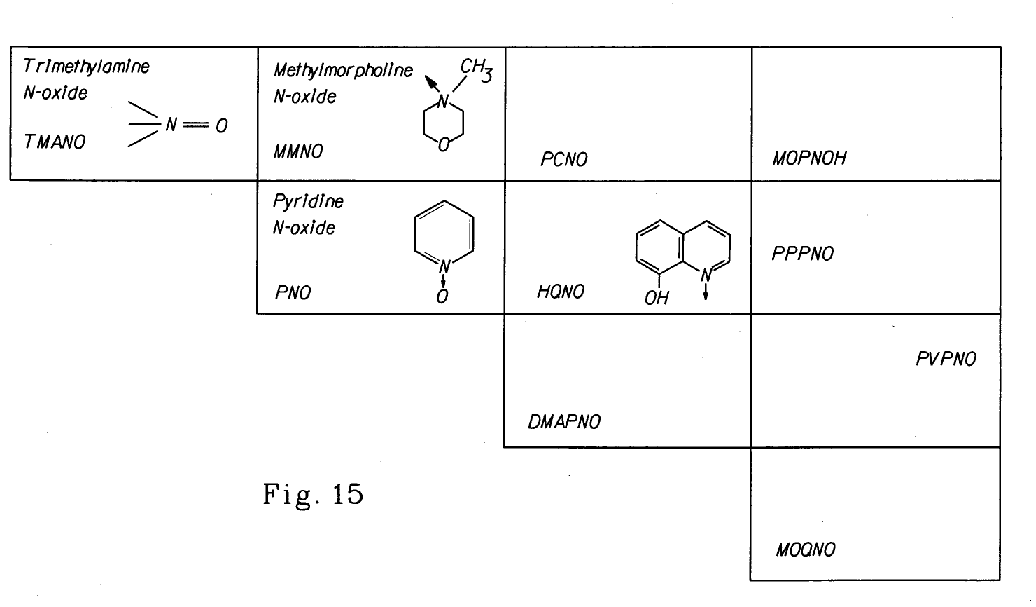

For example, FIG. 15 illustrates N-oxides that may be added to the aqueous feed solution in conjunction with NaBr or in lieu, such as Trimethylamine N-oxide (TMANO), Methylmorpholine N-Oxide (MMNO), Pyridine N-oxide (PNO), Pyridylcarbinol N-oxide (PCNO), 8-Hydroxyquinoline N-oxide (HQNO), 4-Dimethylamine pyridine N-oxide (DMAPNO), Methyoxy pyridine N-oxide hydrate (MOPNOH), 4-(3-Phenylpropyl)pyridine N-oxide (PPPNO), Poly (4-vinyl)pyridine N-oxide (PVPNO), and 6-Methoxyquinoline N-oxide (MOQNO). In one embodiment, at a buffered pH of 9.5 the N-oxide is preferably TMANO.

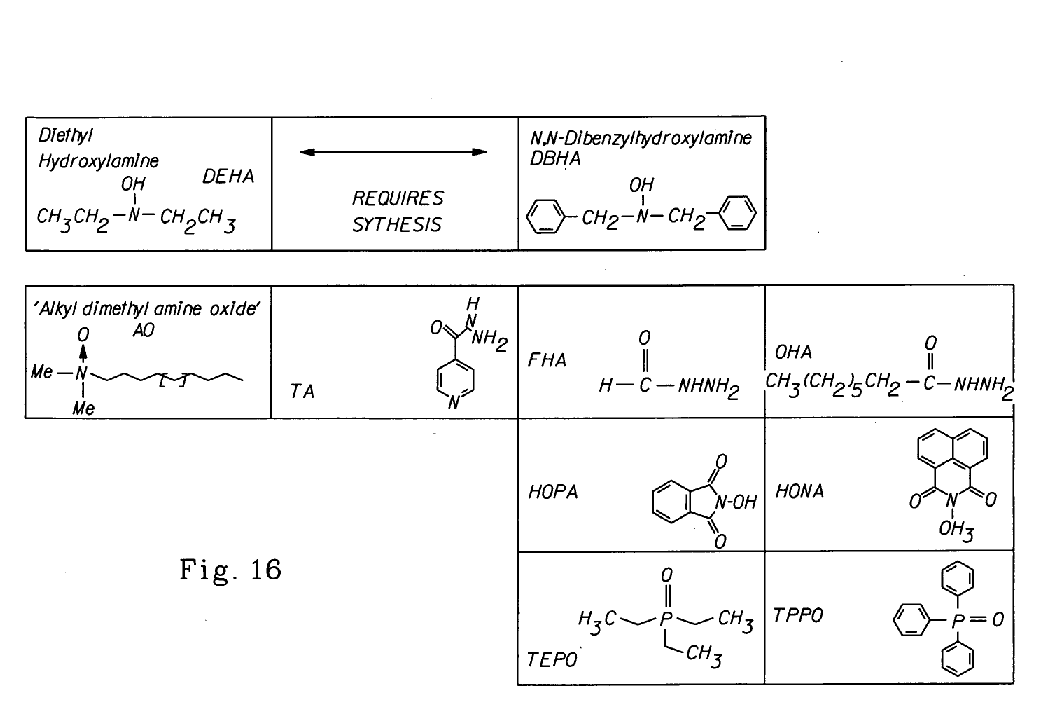

FIG. 16 illustrates amines and oxides that may be added to the aqueous feed solution in conjunction with NaBr or in lieu, such as Diethyl Hydroxylamine (DEHA), N,N-Dibenzylhydroxylamine (DBHA), Alkyl dimethyl amine oxide (AO), Isoniazid (IA), Formic hydrazide (FHA), N-Hydroxyphthalimide (HOPA), Triethylphosphineoxide (TEPO), Octanoic hydrazide (OHA), N-Hydroxynaphthalimide Sodium salt (HONA), and Triphenyl phosphineoxide (TPPO).

### EXAMPLES

### Aqueous Sporocidal Testing Methodology

Bacillius cereus spores, the surrogate for Anthrax, is used in the aqueous sporocidal tests. The closest relatives of Bacillius anthracis are the two species, Bacillus thuringiensis (an insect pathogen) and Bacillius cereus (B. cereus) (a ubiquitous soil isolate and food borne human pathogen). The distinguishing functional features of these species are primarily virulence genes carried on plasmids. The purpose of the aqueous sporocidal testing methodology is to determine the efficacy of chlorine and chlorine dioxide in killing vegetative cells and spores of B. cereus.

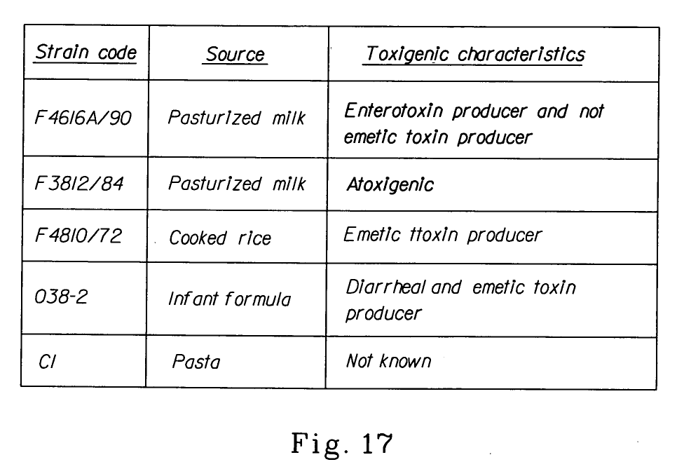

First, a single cocktail with approximately equal population of five strains of B. cereus are used as illustrated in FIG. 17. Second, the vegetative cells and spores are prepared. To grow the vegetative cells, the strains are grown in brain heart infusion (BHI) broth at approximately 30° C. for 24 h. The cultures are then transferred by loop inocula twice at 24 h intervals before inoculating BHI broth from which cells are used to prepare a five-strain mixture comprising approximately equal populations of each strain. These populations are achieved by centrifugation (6000×g for 10 min at approximately 21° C.) of 24 hour cultures, and re-suspending in 30 ml of sterile de-ionized water, and combining predetermined volumes to yield a suspension comprising ca. 10⁸ cfu/ml. This suspension (0.1 ml) is added to 4.9 ml of chemical treatment solution (and water control) to yield the reaction mixture containing a population of 10⁶ cfu/ml.

To grow the spores, suspensions (0.1 ml) of each strain is grown at approximately 30° C. for 24 h and are surface-plated on nutrient agar (BBL/Difco) supplemented with manganese sulfate (50 μg/ml). The plates are incubated at approximately 30° C. for approximately 72 hours, and then held at approximately 4° C. for approximately 40 h before spores are harvested. Sterile de-ionized water (approximately 5 ml) is applied to the surface of each plate, followed by rubbing with a sterile bent glass rod to suspend cells and spores that are not sporulated. Suspensions of each strain collected from 12 plates are course-filtered through sterile glass wool, pooled, and centrifuged (2600×g for 20 min). Pellets are re-suspended in approximately 100 ml of sterile de-ionized water and undergo centrifugation (6000×g for 10 min). The washing procedure is continuously repeated until spores are substantially free of most cell debris originating from the original culture. Suspensions (ca. 50 ml of each strain) are stored at approximately 1-2° C. until used.

The number of spores (cfu/ml) in each stored suspension is measured. Water (approximately 4 ml) in a glass test tube is adjusted to a temperature of approximately 80° C. in a water bath. The stock spore suspension is diluted approximately 10-fold and approximately 1 ml is added to the hot water. After heating for approximately 10 min., and approximately 1 ml is withdrawn and added to approximately 9 ml of sterile 0.1% peptone with a temperature of approximately 21° C. Serially-diluted suspensions are surface plated (0.1 ml) on duplicate plates of brain heart infusion agar (BHIA). Plates are incubated at approximately 30° C. for 24 h before colonies are counted. Populations of spores in stock suspensions are then calculated. The differences in populations among the five strains necessitated centrifugation (6000×g for 10 min) of some suspensions followed by re-suspending spores in different volumes of sterile water. A five-strain mixture of spores serves as an inoculum for chemical treatment solutions and water (control). Preparing the inoculum comprising approximately equal populations of heat-shocked spores of each strain is done immediately before determining the efficacy of chlorine dioxide and chlorine treatments.

Next, the electrochemically generated treatment solutions are prepared using the disclosed portable decontaminant system. NaOCl (Sigma-Aldrich) is added to sterile 0.05 M potassium phosphate buffer (pH 6.8, 21° C.). The free chlorine content is determined using an amperometric titrator, e.g., a Hach Colorimeter (model DR/820, Hach Company, Loveland, Co.). The electrochemically generated chemical solution or water control (4.9 ml, 21° C.) are dispensed into 15×150 mm test tubes. Vegetative cell suspension (0.1 ml) or spore suspension (0.1 ml) are added and mixed. After treatment for 5 min, 5.0 ml of 2× Dey-Engley broth is added and mixed to achieve neutralization. All experiments are replicated three times.

The treated suspensions then undergo microbiological analysis. The treated suspensions are surface plated in quadruplicate (0.25 g ml) and duplicate (0.1 ml) on BHIA. Suspensions serially diluted in peptone water are also surface plated (0.1 ml, in duplicate) on BHIA. Plates are inoculated at approximately 30° C. for 24 h before colonies are counted. Table 1 illustrates the results of these experiments.

TABLE 1
Populations of Bacillus cereus vegetative cells
and spores recovered from water (control) and
chemical solutions after 5-min treatment.

| | | Population¹ | | | | | |
|---|---|---|---|---|---|---|---|
| | | Vegetative cells | | | Spores | | |
| | | | | Reduction | | | Reduction |
| | | | | vs. Water | | | vs. Water |
| Control/ | Cone. | log₁₀ | | log₁₀ | log₁₀ | | log₁₀ |
| treatment | (ppm) | cfu/ml | | cfu/ml | cfu/ml | | cfu/ml |
| Water | | 5.40 | A | — | 6.08 | A | — |
| Chlorine | 200 | 0.52 | D | 4.88 | — | | — |
| | 1000 | — | | — | 0.10 | D | 5.98 |
| Chlorine | 5 | 3.88 | B | 1.52 | 5.93 | AB | 0.15 |
| dioxide | 10 | 3.88 | B | 1.52 | 5.72 | B | 0.36 |
| | 50 | 3.22 | C | 2.18 | 4.74 | C | 1.34 |
| | 100 | 0.15 | E | 5.25 | 0.20 | D | 5.88 |
| | 200 | <0.30² | E | >5.10 | <0.30 | D | >5.78 |

¹Mean values (log₁₀ cfu/ml) that are not followed by the same letter are significantly different (P ≦ 0.05).
²Lower limit of detection is 2 cfu/ml (log₁₀ 0.30 cfu/ml).

As Table 1 illustrates, the 200 ppm ClO₂ treatments result in viable spore counts that are below the limits of detection (i.e., provided complete kill, >6 log reduction) within 5 min. The efficacy of the E- ClO₂ treatments (electrochemically generated chlorine dioxide treatments) after a 5-min exposure is significantly greater than that achieved by treatment with 200 ppm HOCl. Consequently, the E- ClO₂ treatments provide a complete kill in testing and are more effective than equivalent non-electrochemically generated chlorine solutions, and provide a significant and effective alternative to chlorine as a treatment to significantly reduce microbial pathogens.

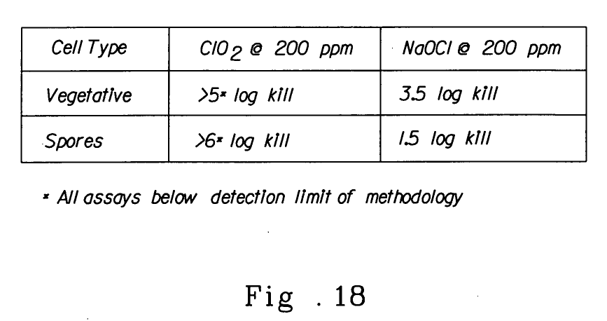

FIG. 18 provides another way of illustrating the results achieved with a Bacillus cereus cocktail of the five different strains. The E- ClO₂ treatment is much more effective in killing the Bacillus cereus spores (i.e., total kill) as compared to the hypochlorite benchmark which only yielded 1.5 log kill. Additionally, it is important to note that few other treatments would have provided total kill of the Bacillus cereus spores since these are particularly difficult to kill.

In Vitro Carrier Testing (Quantitative Use-Dilution Test)

A series of carrier tests are conducted at P&G Sharon Woods Technology Center's (SWTC) Microbiology Laboratory, using E- ClO₂ samples. The method is a quantified modification of the AOAC Use Dilution Test (UDT), which is prescribed by the EPA for hard surface cleaner FIFRA registrations. In this method, the challenge organisms in the presence of 5% horse serum are inoculated and dried on stainless steel cylinders. The inoculated cylinders are exposed to various treatments at ambient temperatures. After approximately 1 minute contact time, the carriers are removed and neutralized. The numbers of surviving organisms are then enumerated and the log₁₀ reductions calculated versus the dry carrier controls, using standard plate counting techniques.

The 40 ppm E- ClO₂ killed microorganisms in carrier testing shows equivalency to 200 ppm HOCl. The 1 minute exposure to 40 ppm E- ClO₂ provides approximately greater than or equal to 5 log reduction against Pseudomonas aeruginosa, a Gram (−) bacterial species that is representative of naturally occurring microbial populations and an opportunistic human pathogen, and an approximately greater than or equal to 5 log reduction against Escherichia coli, a Gram (−) bacterial species commonly associated with food-borne illness. Consequently, the E- ClO₂ treatments provide a complete kill in testing and are more effective than equivalent non-electrochemically generated chlorine solutions, and provide a significant and effective alternative to chlorine as a treatment to significantly reduce microbial pathogens.

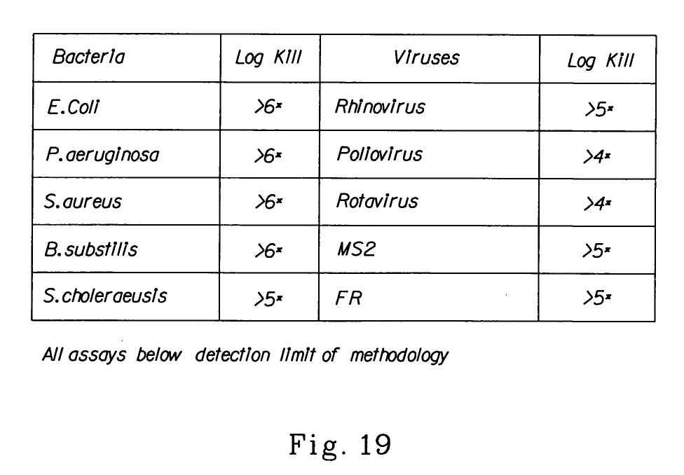

FIG. 19 demonstrates the antimicrobial efficacy of a 1 ppm E —ClO₂ solution tested in various solutions of microorganisms with a decontaminant solution generated by the portable decontaminant system. The contact time is approximately one minute. In all tests, a total kill was achieved, i.e., below the detection limit of the method.

In Vitro Carrier Testing (Germicidal Spray Test)

A series of carrier tests are conducted at the P&G SWTC Microbiology Laboratory, using E- ClO₂ samples. This method is a quantified modification of the AOAC Germicidal Spray Test (GST), which is also prescribed by the EPA for hard surface cleaner FIFRA registrations. In this test, the challenge organisms are inoculated and dried onto glass carriers in the presence of 5% horse serum. The inoculated carriers are then treated by spraying the product on the carriers and allowed to sit for approximately 10 min. After the 10 min contact time, the carriers are removed and neutralized. The numbers of surviving organisms are then enumerated and the log₁₀ reductions calculated versus the dry carrier controls, using standard plate counting techniques.

The 200 ppm E- ClO₂ killed microorganisms in carrier testing shows better efficacy than 200 ppm HOCl. The 10 minute exposure to 200 ppm ClO₂ provides an approximately greater than or equal to 5 log reduction against Pseudomonas aeruginosa, and an approximately greater than or equal to 5 log reduction against Salmonella choleraesuis. Consequently, the E- ClO₂ treatments provide a complete kill in testing and are more effective than equivalent non-electrochemically generated chlorine solutions, and provide a significant and effective alternative to chlorine as a treatment to significantly reduce microbial pathogens.

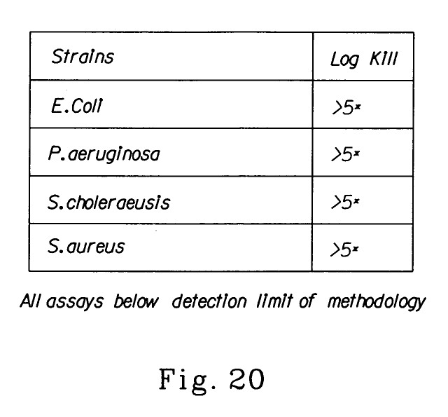

FIG. 20 demonstrates surface test results of testing the E- ClO₂ at 100 ppm concentration on microbes which are deposited on hard substrates. The contact time is ten minutes. Note that all tests showed complete kill of the microorganisms (to below detection limit).

### Efficacy Optimization and Other Uses

It should be appreciated that the combination of chlorine dioxide and hypobromite may also find consumer use applications, such as for household cleaning products, incorporated into air freshening, textiles, wovens, non-wovens, baby care products, health care products, and the like. For example, a household cleaning product could incorporate electrochemically generated chlorine dioxide and hypobromite at lower concentrations. The electrochemically generated chlorine dioxide will range from about 1 ppm to about 200 ppm, and preferably from about 10 ppm to about 100 ppm. The electrochemically generated hypobromite will range from about 20 ppm to about 2000 ppm, and preferably from about 100 ppm to about 1000 ppm.

The disclosed portable decontaminant system 10 (FIGS. 1A-1D), electrochemically generates an oxidant and nucleophile. In a preferred embodiment, the oxidant is chlorine dioxide and the nucleophile is hypobromite. The electrochemically generated chemicals rapidly neutralizes all BWA's and CWA's. The portable decontaminant system is simple, safe, and easy for an individual to use, such as a soldier on a battlefield. The system is also very stable over years of storage and can be readily transported without restrictions. There are minimal or no effects on surface materials. The electrochemical generation of active species resolves the conflict between the required high activity and the need for storage stability and transportability. The reactive species are produced on demand from stable precursors. The disclosed portable decontamination unit is portable, and, scalable.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this' written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for decontaminating a surface comprising the steps of:
providing a decontamination system;
providing aqueous solution, wherein the aqueous solution flows through the decontamination system forming an electrochemically generated effluent solution comprising from about 10 to about 1500 ppm of halogen dioxide and from about 100 to about 1,000 ppm of hypohalite; and
discharging the effluent solution over the surface for decontamination, wherein the decontamination is selected from the group consisting of chemical decontamination, biological decontamination and combinations thereof.

2. The method according to claim 1, wherein the halogen dioxide is chlorine dioxide and the hypohalite is hypobromite.

3. The method according to claim 1, wherein the halogen dioxide is produced in situ.

4. The method according to claim 1, wherein the hypohalite is produced in situ.

5. The method according to claim 1, wherein the decontamination system is a portable system comprising:
a. a flow-through electrolysis cell comprising: an anode, a cathode, and a flow path, wherein the cathode is spaced apart a distance from the anode such that the flow path is defined therebetween;
b. a fluid reservoir in fluid communication with the flow path;
c. an aqueous feed solution located in the fluid reservoir, the aqueous feed solution comprising at least one salt;
d. a direct current power supply; and
e. an outlet port in fluid communication with the flow path through which effluent solution may be discharged;
wherein the aqueous feed solution flows from the fluid reservoir into the flow path; and the direct current power supply provides electric current from the anode through the aqueous feed solution to the cathode, whereby the aqueous feed solution is electrolyzed such that at least a portion of the salt is converted into either a halogen dioxide or hypohalite thereby producing the effluent solution.

6. The method according to claim 5, wherein the aqueous feed solution further comprises an alkali halide salt, at least a portion of which is converted into the hypohalite when the aqueous feed solution is electrolyzed.

7. The method according to claim 5, wherein the system further comprises a second flow-through electrolysis cell in fluid communication with the first flow-through electrolysis cell.

8. A method for decontaminating a surface comprising the steps of:
providing a portable decontamination system;
providing aqueous solution, wherein the aqueous solution flows through the portable decontamination system forming an electrochemically generated effluent solution comprising: from about 500 to about 1500 ppm of a halogen dioxide and from about 1000 to about 100,000 ppm of a nucleophile, wherein the nucleophile is selected from the group consisting of N-oxides, hydroxylamines, amines, and combinations thereof;
and
discharging the effluent solution over the surface for decontamination, wherein the decontamination is selected from the group consisting of chemical decontamination, biological decontamination and combinations thereof.

9. The method according to claim 8, wherein the N-oxide is selected from the group consisting of: TMANO, MMNO, PNO, PCNO, HQNO, DMAPNO, MOPNOH, PPPNO, PVPNO, MOQNO, and combinations thereof.

10. The method according to claim 9, wherein the aqueous solution has a buffered pH from about 9.5 to about 10.5 and the N-oxide is TMANO.

11. The method according to claim 8, wherein the amines are selected from the group consisting of: DEHA, DBHA, AO, IA, FHA, HOPA, TEPO, OHA, HONA, TPPO, and combinations thereof.

12. The method according to claim 8, wherein the halogen dioxide and nucleophile are produced in situ.

13. A portable decontamination system comprising at least one flow-through electrolysis cell, wherein the flow-through electrolysis cell further comprises:
a. an anode, a cathode, and a flow path, wherein the cathode is spaced apart a distance from the anode such that the flow path is formed therebetween;
b. a fluid reservoir in fluid communication with the flow-path;
c. a feed solution located in the fluid reservoir, the feed solution comprising: a solvent, a halogen dioxide salt, and a nucleophilic agent;
d. a direct current power supply; and
e. an outlet port in fluid communication with the flow path;
wherein the feed solution flows from the fluid reservoir into the flow path, and the direct current power supply provides electric current from the anode through the feed solution to the cathode, whereby the feed solution is electrolyzed such that at least a portion of the feed solution is converted into electrochemically generated effluent solution.

14. An electrochemically generated decontamination effluent solution comprising:
from about 500 to about 1500 ppm of a halogen dioxide;
and from about 1000 to about 100,000 ppm of a nucleophile, wherein: the nucleophile is selected from the group consisting of hypohalites, N-oxides, hydroxylamines, amines, and combinations thereof.
